(19) United States
(12) Patent Application Publication
(10) Pub. No.: US 2007/0243126 A1
(43) Pub. Date: Oct. 18, 2007

(54) Oxidation Reaction In the Gaseous Phase In A Porous Medium

(75) Inventors: Bernd Bartenbach, Limburgerhof (DE); Julian Prolss, Worms (DE); Kai Rainer Ehrhardt, Ludwigshafen (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/587,187

(22) PCT Filed: Apr. 21, 2005
(86) PCT No.: PCT/EP05/04306

§ 371 Date: Oct. 23, 2006

(30) Foreign Application Priority Data
Apr. 22, 2004 (DE) 10 2004 019 650.8

(51) Int. Cl. C01B 6/24

(52) U.S. Cl. 423/644

(57) ABSTRACT

The present invention relates to a process for preparing thermodynamically unstable products of the oxidative gas-phase reaction of molecular compounds comprising hydrogen and at least one atom other than hydrogen by stabilized autothermal reaction in a porous medium.

The present invention relates to a process for preparing thermodynamically unstable products of the oxidative gas-phase reaction of molecular compounds comprising hydrogen and at least one atom other than hydrogen by stabilized autothermal reaction in a porous medium.

Gaseous oxygen combines with virtually all elements to form oxygen compounds, with these redox reactions frequently occurring with considerable release of energy and intermediate formation of thermodynamically unstable products. Many thermodynamically unstable products of oxidative gas-phase reactions are important industrial starting materials. This is particularly true of the products of the oxidative gas-phase reaction of element-hydrogen compounds. Thus, it is known that various products of value can be prepared from hydrocarbon starting materials, e.g. for the preparation of unsaturated hydrocarbons such as olefins and alkynes and also synthesis gas, by subjecting saturated aliphatic hydrocarbons (paraffins) and mixtures thereof to an oxidative gas-phase reaction. Both catalytically induced and uncatalyzed processes are known. Furthermore, a distinction is made between allothermal processes in which the energy required for the reaction is introduced from the outside and autothermal processes in which the heat energy required results from partial combustion of a starting material. Important prerequisites of all these processes are rapid introduction of energy to a high temperature, generally short residence times under the reaction conditions and rapid cooling (“quenching”) of the reaction gases in order to make it possible to isolate the reactive products which are unstable under the reaction conditions, before they undergo an undesirable further reaction or are substantially oxidized.

For example, it is known that acetylene can be prepared in uncatalyzed processes which are based on the pyrolysis or partial oxidation of hydrocarbons. Starting substances used here can be, for example, natural gas, various petroleum fractions (e.g. naphtha) and even oil residues (immersed flame process). In pyrolytic or oxidative processes for preparing acetylene, thermodynamic and kinetic parameters have in principle a critical influence on the choice of reaction conditions. Important prerequisites of such processes are generally rapid introduction of energy, short residence times of the starting materials and reaction products, low partial pressure of the acetylene and rapid quenching of the gases formed. Thus, for example, EP-A-1 041 037 describes a process for preparing acetylene and synthesis gas by thermal treatment of a starting mixture comprising one or more hydrocarbons together with an oxygen source, with the starting mixture being heated to a maximum of 1400° C., reacted in a reactor and subsequently cooled.

The preparation of olefins in uncatalyzed high-temperature processes is also known. In Petrol. Refiner, 29 (September 1950), 217, R. M. Deanesly describes the autothermal cracking of hydrocarbon streams to produce ethene. Here, the reaction gases are passed through heat exchangers in which the feed streams are preheated.

In Petrol. Refiner, 35, No. 7, pp. 179-182, R. L. Mitchel describes the mechanism of the uncatalyzed gas-phase oxidation of hydrocarbons and the influence of various parameters on this reaction.

WO 00/06948 describes a process for utilizing a hydrocarbon-containing fuel with use of an exothermic prereaction in the form of “cold flame”.

GB-A-794,157 describes a process for preparing acetylene and ethylene by partial combustion of methane and/or ethane in two successive reaction zones, with the first reaction zone being operated at a pressure above atmospheric pressure and the second being operated at a lower pressure.

GB-A-659,616 describes a process for the oxidative cracking of nonaromatic hydrocarbon streams, in which these are preheated and subjected together with a likewise preheated oxygen-containing gas to a partial combustion. The oxygen content is in the range from 10 to 35% based on the hydrocarbon used. The reaction zone employed is designed to generate turbulent flow of the reaction gases, so that mixing of combustion gases with fresh fuel is made to occur in the reaction zone in this process.

GB-A-945,448 describes a process for preparing olefins from saturated aliphatic hydrocarbon streams by reaction with oxygen at temperatures of less than 700° C. The ratio of hydrocarbon starting material to oxygen in the reaction is greater than about 2:1. The reactants used are mixed in a mixing zone with generation of turbulence, with the resulting turbulent flow being able to continue into the reaction zone. Mixing of combustion gases with fresh fuel in the reaction zone can thus occur in this process, too.

U.S. Pat. No. 3,095,293 describes a process for preparing ethene by incomplete combustion of naphtha in the presence of steam. In this process, acetylene and CO₂ are firstly removed from the reaction gas by absorption processes, the reaction gas is subsequently passed to a plurality of cooling steps in heat exchangers and partially condensed, ethene is isolated as main product from the condensate and the uncondensed fraction is burnt, with the heat evolved being utilized for generating the steam. As regards the combustion apparatus used, reference is made to U.S. Pat. No. 2,750,434.

U.S. Pat. No. 2,750,434 describes a process for converting hydrocarbons into unsaturated hydrocarbons, aromatic hydrocarbons and acetylene. For this purpose, the hydrocarbons are subjected to a cracking process at high temperatures in the range from about 700 to 1900° C. and short reaction times in the millisecond range. The reaction is carried out in a tangential reactor with a permanent pilot flame which produces hot combustion gases brought into contact with the hydrocarbon fed in. The process thus involves firstly separated combustion in the pilot flame and subsequently the further reaction of the feed hydrocarbons in the presence of the combustion gases in a subsequent stage.

Processes using catalysts have also been described. Thus, A. Beretta et al. in Chem. Eng. Sci. 56 (2001), 779-787, describe the influence of a heterogeneous catalyst in the high-temperature preparation of ethene. Furthermore, in J. Catal. 184 (1999), 455-468 A. Beretta et al. describe the influence of a Pt/Al₂O₃ catalyst on the oxidative dehydrogenation of propane in a tube reactor, and in J. Catal. 184 (1999), 469-478, A. Beretta et al. describe the preparation of olefins by platinum-catalyzed oxidative dehydrogenation of propane under autothermal conditions.

WO 00/15587 describes a process for preparing monoolefins and synthesis gas by oxidative dehydrogenation of gaseous paraffinic hydrocarbons by autothermal cracking of ethane, propane and butanes. The reaction can be carried out in the presence or absence of a catalyst, but the use of a catalyst for the reaction of fuel-rich, nonignitable mixtures is taught.

In J. Phys. Chem. 97 (1993), 11815-11822, M. Huff et al. describe the preparation of ethene by oxidative dehydrogenation of ethane, and in J. Catal. 149 (1994), 127-141, M. Huff et al. describe the preparation of olefins by oxidative dehydrogenation of propane and butane. The reaction is in each case carried out over catalyst monoliths coated with Pt, Rh or Pd.

WO 00/14180 describes a process for preparing olefins, in which paraffins are reacted with oxygen in the presence of a monolithic catalyst based on a metal of transition group Vil under autothermal conditions.

In Science 285 (1999), 712-715, A. S. Bodke et al. report an increase in the selectivity in the partial oxidation of ethane to ethene as a result of addition of hydrogen to the reaction mixture. The reaction is carried out in the presence of a platinum-tin catalyst.

WO 01/14035 describes a process for preparing olefins in which paraffins or paraffin mixtures are reacted with oxygen in the presence of hydrogen and a catalyst based on a metal of transition group Vil under autothermal conditions.

There continues to be a great need for processes and corresponding apparatuses which make it possible to stabilize thermal partial gas-phase oxidation reactions for the isolation of thermodynamically unstable products.

The use of porous structures, e.g. ceramics, as stabilizers in combustion reactions employed for direct or indirect heating, for example of buildings or for provision of hot water, is known. Here, very complete utilization of the chemical energy stored as calorific value in the usually gaseous fuels is sought. The combustion conditions are in this case essentially oxidizing, i.e. an excess of oxygen is used in order to ensure very complete combustion. In a first variant, a porous structure serves to supply fuel and air simultaneously, usually in completely premixed form, to a combustion zone located outside the structure. Stabilization is effected at low flow velocities and leads to an even flame carpet made up of small individual flames resulting from the pores. Heat exchange between the flame zone and the surface of the structure results in a high temperature of the stabilizer body and correspondingly to preheating of the fuel/air mixture supplied. This results in the stabilizing properties of this form of burner, which is also referred to as ceramic surface burner. The good radiation properties of the ceramic surface result in high heat transfer rates by means of radiant heat, so that this burner is suitable for radiant heating, e.g. for large industrial halls.

It is also already known that the combustion of premixed gases can occur partly or completely within a porous structure. Thus, K. Pickenätcker describes low-emission gas heating systems based on stabilized combustion in porous media in her thesis at the Universität Erlangen-Nürnberg, published in VDI Fortschrittsberichte, series 6, No. 445 (2000). Use of these pore burners for thermal partial gas-phase oxidation reactions is not described. On the basis of the applications described hitherto for the porous structures in classical combustion reactions, it would have been assumed that such structures are unsuitable for use with fuel-rich starting mixtures (reducing atmosphere) and at high temperatures.

It is an object of the present invention to provide a process for preparing and isolating thermodynamically unstable products of the oxidative gas-phase reaction of hydrogen-containing compounds. The process should not only be suitable for reaction of fuel-rich starting mixtures but also be able to be used at high reaction temperatures. If hydrocarbons are used, hydrocarbon feedstocks available in petrochemical complexes should preferably be used.

It has surprisingly been found that this object can be achieved by a process in which fuel-rich (rich) hydrogen-containing compounds are subjected to an autothermal reaction which occurs at least partly within a porous medium.

The present invention accordingly provides a process for preparing thermodynamically unstable products of the oxidative gas-phase reaction of molecular compounds comprising hydrogen and at least one atom other than hydrogen, which comprises
a) providing a starting mixture comprising the molecular compound(s) and at least one oxygen source, with the fuel number of the mixture being at least 3,
b) passing the starting mixture through at least one reaction zone containing a porous medium and thus subjecting it to an autothermal reaction which is stabilized by the medium and occurs at least partly in the interior of the porous medium to give a reaction gas,
c) subjecting the reaction gas obtained in step b) to rapid cooling.

For the purposes of the present invention, thermodynamically unstable products are reactive products (intermediates) which are not (yet) in a stable energy state but would react to form subsequent products if the reaction were not stopped by rapid cooling.

The fuel number is defined as the stoichiometric ratio of the oxygen required for complete combustion of the molecular compounds (e.g. hydrocarbons) present in the starting mixture used to the oxygen available for combustion. According to a general definition, the fuel number corresponds to the reciprocal of the air number. The fuel number of the starting mixture is preferably at least 3, particularly preferably at least 6.5, in particular at least 10.

For the purposes of the present invention, an autothermal reaction is a reaction in which the heat energy required results from partial combustion of a starting material.

For the purposes of the present invention, stabilization of a thermal partial gas-phase oxidation reaction encompasses stabilization both in terms of location and time. Thus, induction (ignition) of the autothermal reaction occurs in a narrow induction zone (“flame front”) within the reaction zone. This induction zone is followed in a downstream direction by the actual reaction zone. Neither backignition into a region upstream of the induction zone nor uncontrolled progression of the reaction in the direction of flow occurs. In addition, reaction gases whose composition does not alter significantly over time after the rapid cooling can be obtained over the entire duration of the reaction. The process of the invention is thus suitable for the continuous preparation of thermodynamically unstable products under essentially steady-state conditions.

It has surprisingly been found that stabilization of the autothermal reaction is possible even in the case of very fuel-rich starting mixtures (fuel numbers up to about 20). The stabilization advantageously occurs together with simultaneously good load regulation behavior. Even under the strongly reducing conditions of the fuel-rich starting mixtures, generally no material-related problems occur, especially when using porous media based on SiC. In addition, a noncatalytic reaction advantageously proceeds even at relatively low temperatures of 900° C. and sometimes even down to 800° C.

According to the invention, the reaction of the starting mixture occurs in a reaction zone containing at least one porous medium, with the reaction occurring at least partly in the interior of the porous medium. In particular, the induction of the autothermal reaction proceeds entirely in the interior of the porous medium.

The present invention encompasses, in a useful embodiment, at least partial mixing of the molecular compound(s) used and the oxygen source prior to the autothermal reaction (premixed combustion). Here, a distinction is made between the following types of premixing:
macroscopic mixing: The transport of the material occurs by means of large turbulences (distributive mixing) and also by formation of finer structures due to turbulence cascades (dispersive mixing). In the case of laminar flow, macroscopic mixing takes place by means of laminar folding which is brought about by means of the porous medium or other internals (laminar mixing) in the process of the invention. In the case of macroscopic mixing, mixing occurs essentially by means of inertial forces and convection.
mesoscopic mixing: The smallest turbulences roll up layers of differing species concentration (engulfment). Stretching of the turbulences decreases the thickness of the individual laminar layers (deformation). In the case of mesoscopic mixing, mixing occurs essentially by means of convection and viscous forces.
microscopic mixing: On this finest length scale, mixing occurs exclusively by molecular diffusion.

In the process of the invention, the starting components are preferably in at least macroscopically mixed form before commencement of the autothermal reaction.

The stabilization of the reaction preferably occurs according to the concept of Péclet number stabilization. The Péclet number Pe is defined as the ratio of heat production by the reaction to heat removal by the thermal conductivity of the gas: Pe=(sₗd)/a(sₗ=laminar flame velocity, d=equivalent pore size, a=thermal conductivity of the gas mixture). In Péclet number stabilization, a reaction zone comprising at least two subzones, for example a first subzone (region A) and a second subzone (region B), is used. The first subzone serves as a flame barrier and in this zone more heat is removed than could be produced by combustion. In the second subzone, the actual reaction zone, appreciable heat transfer between solid and gas phases occurs, by means of which the combustion is stabilized. The second subzone can in turn be divided into an induction zone and the further reaction zone located downstream. The first subzone (region A) can be part of the porous medium, e.g. in the form of a first part medium having a first pore size which is smaller than that of the second part medium (second subzone, region B). The first subzone can also be realised hydrodynamically, e.g. by means of a tube having an appropriate cross section through which the flow velocity is sufficiently high. The second subzone comprises a porous medium in which at least part, preferably all, of the induction zone (flame front) is located. The reaction zone located downstream of this induction zone can be entirely within the porous medium, extend beyond the porous medium or lie entirely outside the porous medium. The Péclet number Pe indicates whether stable combustion takes place at every point of a reactor (flame barrier, induction zone, reaction zone). The Péclet number in the first subzone (region A) is preferably less than 50. Suitable Péclet numbers for the induction zone are, in the absence of a catalyst, in the range from, for example, 50 to 70.

In addition to Péclet number stabilization, the reaction can be stabilized by radiation stabilization. Radiation stabilization occurs predominantly in the interior of the porous medium and also outside in the vicinity of the free surface. In this form of stabilization, the inflowing starting mixture is effectively preheated by heat conduction and radiation opposite to the flow direction and combustion is thus kept stable.

Both in the case of Péclet number stabilization and in the case of radiation stabilization, exploitation of the solid state heat transport in the porous medium is an important feature in stabilization of the autothermal reaction.

In one useful embodiment, the reaction zone extends downstream beyond the porous medium. In the flame occurring in this region, macroscopic heat transport but essentially no macroscopic heat transfer occurs in a direction opposite to the flow direction. In this embodiment, it is possible for the longitudinal extension of the porous medium to be small relative to the total reaction zone and the length of the porous medium to be, for example, a maximum of 90%, preferably a maximum of 50%, in particular a maximum of 20%, of the total length of the reaction zone. In a useful embodiment, only the induction zone is formed by the porous medium.

The porous medium preferably has a pore volume of at least 40%, preferably at least 75%, based on the total volume of the medium.

Materials suitable as porous media are, for example, conventional packing elements such as Raschig rings, saddles, Pall® rings, wire spirals or wire mesh rings which can be made of different materials and are suitable for coating with a catalytically active component. The packing elements can, in a useful embodiment, be introduced as a loose bed into the reaction zone. Preference is given to using shaped bodies which are preferably installed in the form of ordered packings in the reactor as porous media. Owing to a multiplicity of flow channels, these have a large surface area, based on their volume. Such shaped bodies will hereinafter also be referred to as monoliths. The shaped bodies or monoliths can be made up of, for example, woven fabrics, knitteds, films, expanded metals and/or metal sheets.

Particular preference is given to shaped bodies which are made up of open-celled foams. These foams can, for example, consist of ceramic.

Suitable materials for the porous media are, for example, oxidic materials such as Al₂O₃, ZrO₂ and/or SiO₂. Further suitable materials are SiC materials. Also suitable are temperature-resistant metallic materials, for example iron, spring steel, Monel, chromium steel, chromium-nickel steel, titanium, CrNiTi steels and CrNiMo steels or heat-resistant steels having the material numbers 1.4016, 1.4767, 1.4401, 2.4610, 1.4765, 1.4847, 1.4301, 1.4742. Very particular preference is given to using bodies composed of Al₂O₃, ZrO₂, SiO₂, SiC, carbon-reinforced SiC and SiC with silicon binders as porous media.

Suitable woven fabrics are, for example, fabrics made of fibers of the oxidic materials mentioned, e.g. Al₂O₃ and/or SiO₂, or of weavable metal wires. Woven fabrics having various types of weave, e.g. plain-woven fabrics, twill fabrics, graded fabrics and other special weaves, can be produced from the wires and fibers mentioned. These woven fabrics can be combined into multilayer fabric composites.

Suitable porous shaped bodies are made up of a plurality of layers of corrugated, creased and/or smooth woven fabrics which are arranged so that adjacent layers form channels. Monoliths in which the woven fabrics are partly or completely replaced by metal sheets, knitteds or expanded metals can likewise be used.

The porous medium can further comprise at least one catalytically active component. This is preferably located on the surface of the abovementioned porous media. Coating of the catalyst supports with the catalytically component is carried out by the methods customary for this, e.g. impregnation and subsequent calcination.

The autothermal reaction according to the invention preferably occurs noncatalytically, i.e. in the absence of catalysts as have been described in the prior art,for example for the oxidative dehydrogenation of saturated hydrocarbons.

The reaction zone comprising the porous medium is preferably configured as a system with a low degree of backmixing. It preferably has esssentially no macroscopic mass transfer in the direction opposite to the flow direction.

The process of the invention is in principle suitable for the oxidative gas-phase reaction of hydrogen-containing compounds which can be brought into the gas phase under the reaction conditions. In a first embodiment, they are element-hydrogen compounds, in particular element-hydrogen compounds of nonmetals and semimetals and in particular hydrocarbons. Compounds suitable for use in the process of the invention are, for example, nitrogen-hydrogen compounds such as ammonia and hydrazine, phosphorus-hydrogen compounds such as phosphane, hydrogen sulfide, halogen-hydrogen compounds such as HF, HCl, HBr and HI, hydrocarbons, etc., and mixtures thereof. In a second embodiment, the compounds are hydrogen-containing compounds which additionally contain at least two further atoms which are different from one another. Such compounds preferably include compounds containing carbon, nitrogen and hydrogen in molecularly bound form, e.g. nitriles such as acetonitrile, propionitrile, etc.

The process of the invention can be used for the simultaneous preparation of essentially one or more products of value.

When ammonia is used as starting material, the products obtained include, for example, nitrogen monoxide, nitrogen dioxide, HNO₂, HNO₃, HCN, etc.

When nitriles are used as starting material, the products obtained include, for example, HCN, CO, H₂, alkanes and alkynes.

When hydrocarbons are used as starting material, the products obtained are preferably selected from among olefins, alkynes, dealkylated aromatics, synthesis gas, etc.

When hydrocarbons in admixture with hydrogen halides are used as starting material, the products obtained include haloalkanes. Thus, for example, the oxyhydrochlorination of ethylene/HCl mixtures gives dichloroethane, an important precursor of vinyl chloride.

In the process of the invention, preference is given to using at least one hydrocarbon as starting material and obtaining at least one olefin as thermodynamically unstable product. The olefin obtained is then preferably selected from among ethene and/or propene. In addition, further higher olefins such as butenes, pentenes, etc., can be obtained.

When using at least one hydrocarbon, further products of value obtained are generally hydrogen and carbon monoxide which can be isolated as mixtures (known as synthesis gas). Synthesis gas is an important C₁ building block which has many uses (oxo process, Fischer-Tropsch synthesis, etc.).

In addition, further unsaturated hydrocarbons can be obtained as products of value. These are preferably selected from among alkynes, in particular acetylene (ethyne), aromatics, in particular benzene, and mixtures thererof. In a specific embodiment, the process is useful for at least partial dealkylation of alkylated aromatics, e.g. BTX fractions. Further products of value which can be obtained are, for example, short-chain alkanes such as methane. Suitable embodiments of the process for obtaining at least one of the abovementioned additional products are described in detail below.

The process of the invention makes it possible to prepare the abovementioned products of value, in particular olefins, from a large number of different starting hydrocarbons and hydrocarbon mixtures. The composition of the reaction gas can be controlled, inter alia, by means of the following parameters:
composition of the starting mixture (type and amount of hydrocarbons, type and amount of oxygen source, additional components) and
reaction conditions in the autothermal reaction (reaction temperature, residence time, introduction of reactants into the reaction zone).
   Step a)

A fuel-rich (rich) starting mixture is provided for the reaction.

The starting mixture provided in step a) preferably comprises at least one hydrocarbon. In particular, the hydrocarbon provided in step a) is selected from among alkanes, aromatics and alkane- and/or aromatic-containing hydrocarbon mixtures. Hydrocarbon mixtures can in principle contain the individual components in any amounts. In the case of mixtures comprising at least one alkane and at least one aromatic, either alkanes or aromatics can be present in excess. Suitable alkanes are, for example, low molecular weight C₁-C₄-alkanes which are gaseous under normal conditions (methane, ethane, propanes, butanes) and also relatively high molecular weight alkanes which are liquid or solid under normal conditions, for example C₅-C₃₀-alkanes (pentanes, hexanes, heptanes, octanes, nonanes, etc.). Suitable aromatics are, for example, benzene, fused aromatics such as naphthalene and anthracene and their derivatives. These include, for example, alkylbenzenes such as toluene, o-, m- and p-xylene and ethylbenzene.

The hydrocarbons are preferably used in the form of a natural or industrially available hydrocarbon mixture in step a). These mixtures are preferably selected from among natural gases, liquefied gases (propane, butane, etc), light petroleum spirit, pyrolysis gasolene and mixtures thereof. The hydrocarbon mixture is preferably selected from among light petroleum spirit, pyrolysis gasolene or fractions or downstream products of pyrolysis gasolene and mixtures thereof. Pyrolysis gasolene is obtained in steam cracking of naphtha and has a high aromatics content. Preferred downstream products of pyrolysis gasolene are its (partial) hydrogenation products. A further preferred mixture of aromatics is the BTX aromatics fraction which consists essentially of benzene, toluene and xylenes.

To prepare product mixtures which have high proportions of olefins, in particular of ethene and/or propene, preference is given to using hydrocarbons which consist of at least one alkane or have a high alkane content.

To prepare product mixtures having a high proportion of nonalkylated aromatics (e.g. benzene) or aromatics having low proportions of alkyl substituents, preference is given to using hydrocarbons which consist of alkylaromatics or have a high proportion of alkylaromatics. These are subjected to partial or complete dealkylation under the conditions of the autothermal, noncatalyzed reaction according to the invention.

The oxygen source used in step a) is preferably selected from among molecular oxygen, oxygen-containing gas mixtures, oxygen-containing compounds and mixtures thereof. In a preferred embodiment, molecular oxygen is used as oxygen source. This makes it possible to keep the content of inert compounds in the starting mixture low. However, it is also possible to use air or air/oxygen mixtures as oxygen source. Oxygen-containing compounds used are, for example, water, preferably in the form of water vapor, and/or carbon dioxide. When carbon dioxide is used, this can be recycled carbon dioxide from the reaction gas obtained in the autothermal reaction.

The starting mixtures used in the process of the invention can comprise at least one further component in addition to the hydrocarbon component and the oxygen component. Such components include, for example, recirculated reaction gas and recycle gases from the fractionation of the reaction gas, e.g. hydrogen, crude synthesis gas, CO, CO₂ and unreacted starting materials, and also further gases to influence the yield of and/or selectivity to particular products, e.g. hydrogen.

Step b)

Step b) of the process of the invention comprises in principle the following individual steps: if appropriate preheating of at least one component, if appropriate premixing of at least part of the components, initiation of the autothermal reaction, autothermal reaction. Initiation of the autothermal reaction and autothermal reaction go over directly into one another.

The components forming the starting mixture can be partly or completely premixed prior to the reaction. In a preferred embodiment, only partial mixing of the molecular compound(s) used and the oxygen source is effected prior to the autothermal reaction (premixed combustion). This (partial) premixing can, as described above, be effected by macroscopic mixing which is, for example, brought about by means of the porous medium or other internals.

Before, during or after premixing or in place of premixing, part of the components or all components can be preheated. Gaseous components are preferably not preheated prior to initiation of the autothermal reaction. Liquid components are preferably vaporized and only then mixed with gaseous components or fed to the initiation of the autothermal reaction.

In the autothermal reaction, the starting mixture is heated to a temperature of preferably not more than 1400° C. This can be achieved by introduction of energy and/or an exothermic reaction of the starting mixture. Ignition of the starting mixture preferably occurs in the interior of the porous medium (induction zone). Initiation can, for example, be effected by appropriately intensive external heating of the porous medium in the region of the induction zone. Initiation can also be effected by means of a pilot burner integrated into the porous medium. Initiation can also be effected by brief introduction of a catalyst into the induction zone.

In the case of initiation of the exothermic reaction in the presence of a catalyst, a distinction is made between one-off ignition of the autothermal reaction by means of a catalyst introduced for this purpose and stabilization of the ignition by means of a catalytically active composition permanently present in the porous medium. Preference is given to neither stabilization of ignition nor the autothermal reaction in the presence of a permanently present catalyst being employed.

The initiation of the autothermal reaction is followed by the reaction under autothermal conditions. Here, the reaction zone can, as indicated above, be located completely within the porous medium or preferably extend downstream beyond the porous medium. In both cases, macroscopic heat transport but essentially no macroscopic mass transfer in the direction opposite to the flow direction occurs in the reaction zone. Furthermore, utilization of solid-state heat transport in the porous medium is an important feature in the stabilization of the autothermal reaction.

The heat of reaction liberated by partial combustion of the starting mixture effects thermal treatment of the starting mixture for preparing a mixture according to the invention of thermodynamically unstable products. The reaction types forming the basis of this reaction include combustion (total oxidation), partial combustion (partial oxidation or oxidative pyrolysis) and pyrolysis reactions (reactions without participation of oxygen).

The reaction in step b) preferably occurs at a temperature in the range from 600 to 1300° C., preferably from 800 to 1200° C. The residence time of the reaction mixture in the reaction zone is preferably from 0.01 s to 1 s, particularly preferably from 0.02 s to 0.2 s.

The reaction for preparing the product mixture obtained according to the invention can, according to the process of the invention, be carried out at any pressure, preferably a pressure in the region of atmospheric pressure.

To carry out the reaction in step b), it can be advantageous to use a pore burner as is described in the thesis by K. Pickenätcker, Universität Erlangen-Nürnberg, VDI Fortschrittsberichte, series 6, No. 445 (2000), which is hereby fully incorporated by reference.

Step c)

The reaction of the reaction mixture in step b) is, according to the invention, followed by rapid cooling of the resulting reaction gases in step c). This can be achieved by direct cooling, indirect cooling or a combination of direct and indirect cooling. In the case of direct cooling (quenching), a coolant is brought into contact with the hot reaction gases in order to cool them. In the case of indirect cooling, heat energy is taken from the reaction gas without the latter coming into direct contact with a coolant. Preference is given to indirect cooling, since this generally makes effective utilization of the heat energy transferred to the coolant possible. For this purpose, the reaction gases can be brought into contact with the exchange surfaces of a customary heat exchanger. The heated coolant can, for example, be used for heating the starting materials in the process of the invention or in a different endothermic process. Furthermore, the heat taken from the reaction gases can also be used, for example, for generating steam. Combined use of direct cooling (prequench) and indirect cooling is also possible, with the reaction gas obtained in step c) preferably being cooled to a temperature of not more than 1000° C. by direct cooling (prequench). Direct cooling can, for example, be carried out by introduction of quenching oil, water, steam or cold recycle gases. When hydrocarbon compositions are used as quenching medium, cracking processes can be effected at the same time (cracking of the hydrocarbons present in the quenching medium).

Step d)

To work up the reaction gas obtained in step c), it can be subjected to at least one fractionation and/or purification step d). To fractionate the reaction gas, it can, for example, be subjected to a fractional condensation or the liquefied reaction gases can be subjected to a fractional distillation. Suitable apparatuses and processes are known in principle to those skilled in the art. Individual components can be isolated from the reaction gas by scrubbing with suitable liquids or can be obtained by fractional adsorption/desorption, for example. In this way, it is possible, for example, to separate off alkynes, in particular acetylene, by means of an extractant, for example N-methylpyrrolidone or dimethylformamide.

As described above, the process of the invention makes it possible to prepare additional unsaturated hydrocarbons other than olefins.

In a specific embodiment of the process of the invention, at least one dealkylated aromatic, in particular benzene, is prepared. For this purpose, the starting mixture provided in step a) comprises at least one alkylaromatic. This starting mixture is then preferably selected from among pyrolysis gasolene and partially hydrogenated pyrolysis gasolene. A preferred mixture of aromatics used is the BTX aromatics fraction. In this embodiment, the reaction in step b) is preferably carried out at a temperature in the range from 900 to 1250° C., preferably from 950 to 1150° C. The residence time of the reaction mixture in the reaction zone is preferably from 0.05 s to 1 s in this embodiment.

In a further specific embodiment of the process of the invention, at least one alkyne is prepared. For this purpose, the starting mixture provided in step a) comprises at least one alkane. In this embodiment, the reaction in step b) is preferably carried out at a temperature in the range from >1150 to 1400° C., preferably from >1250 to 1400° C. The residence time of the reaction mixture in the reaction zone is preferably from 0.01 s to 0.1 s in this embodiment.

The invention is illustrated in more detail by the following nonlimiting examples.

### EXAMPLES

The following examples were carried out in a tube reactor (ratio of length to diameter (L/D)=60) which was to a good approximation operated adiabatically. Liquid feed streams were prevaporized. All feed streams were fed into the reactor in premixed form. Initiation and stabilization of the autothermal reaction was ensured by use of a pore burner (foamed ceramic having a porosity of about 80%). The product gas was quenched by indirect cooling.

### Example 1

Partial oxidation of ethane in a gas mixture consisting of 61% by volume of ethane, 21% by volume of oxygen and 18% by volume of nitrogen gives ethylene in a molar carbon yield of 51% at an ethane conversion of 83%. The product gas further comprises methane, synthesis gas (CO and H₂), water vapor and nitrogen. In addition, small amounts of propene, CO₂ and soot are formed.

### Example 2

Partial oxidation of ethane (33% by volume of the raw gas) and xylene (12% by volume of the raw gas) by means of oxygen (24% by volume of the raw gas) with addition of water vapor (31% by volume of the raw gas) gives ethylene in a molar carbon yield of 23%. The yield of toluene is 4% and that of benzene is 19%. Further product gas components are methane, synthesis gas, water vapor and soot and small amounts of propene and CO₂.

### Example 3

Partial oxidation of octane (35% by volume of the raw gas) by means of oxygen (35% by volume of the raw gas) with addition of water vapor (30% by volume of the raw gas) gives ethylene in a molar carbon yield of 48%. The yield of propene is 12% and that of benzene is 4%. Further product gas components are methane, sysnthesis gas, water vapor and small amounts of ethyne, CO₂ and soot.

### Example 4

Partial oxidation of partially hydrogenated pyrolysis gasolene from a steam cracker (85% by volume of aromatics/15% by volume of aliphatics) by means of oxygen (16% by volume of the raw gas) in the presence of water vapor (40% by volume of the raw gas) gives ethylene in a molar carbon yield of 10% and benzene in a molar carbon yield of 33%. Further product gas components are methane, synthesis gas, water vapor, soot and small amounts of ethyne, toluene, xylene and CO₂.

### Example 5

Partial oxidation of propionitrile in a gas mixture consisting of 31% by volume of propionitlrile, 31% by volume of oxygen and 38% by volume of water vapor gives an N-based HCN yield of 89%. The product gas further comprises N₂ and NH₃ as nitrogen-containing components. In addition, methane, synthesis gas (CO and H₂) and acetylene are formed.

1. A process for preparing at least one thermodynamically unstable product of the oxidative gas-phase reaction of at least one molecular compound wherein the at least one molecular compound comprises hydrogen and at least one atom other than hydrogen, comprising
a) providing a starting mixture comprising the at least one molecular compound and at least one oxygen source, wherein the fuel number of the starting mixture is at least 3,
b) passing the starting mixture through at least one reaction zone containing a porous medium and thus subjecting it to an autothermal reaction which is stabilized by the medium and occurs at least partly in the interior of the porous medium to give a reaction gas,
c) subjecting the reaction gas obtained in step b) to rapid cooling.

2. The process according to claim 1, wherein the induction of the autothermal reaction occurs within the porous medium.

3. The process according to claim 1, wherein the starting mixture components are in at least macroscopically mixed form before commencement of the autothermal reaction.

4. The process according to claim 1, wherein stabilization of the reaction occurs substantially or entirely by means of Péclet number stabilization.

5. The process according to claim 1, wherein the porous medium has a pore volume of at least 40%, based on the total volume of the medium.

6. The process according to claim 1, wherein shaped bodies, are used as porous media.

7. The process according claim 1, wherein the porous medium further comprises at least one catalytically active component.

8. The process according to claim 1, wherein the fuel number of the starting mixture is at least 4.

9. The process according to claim 1, wherein the at least one molecular compound comprises at least one hydrocarbon.

10. The process according to claim 9, wherein the at least one hydrocarbon is selected from the group consiting of alkanes, aromatics alkane-containing hydrocarbon mixtures, aromatic-containing hydrocargon mixtures and mixtures thereof.

11. The process according to claim 10, wherein the at least one hydrocarbon in step a) is used in is in the form of a natural or industrially available hydrocarbon mixture.

12. The process according to claim 11, wherein the hydrocarbon mixture is selected from the group consiting of natural gases, liquefied gases, petroleum fractions, petroleum pyrolysates and mixtures thereof.

13. The process according to claim 12, wherein the hydrocarbon mixture is selected from among the group consiting of light petroleum spirit, pyrolysis gasolene, fractions and subsequent products of pyrolysis gasolene and mixtures thereof.

14. The process according to claim 1, wherein the at least one oxygen source is selected from the group consisting of molecular oxygen, oxygen-containing gas mixtures, oxygen-containing compounds and mixtures thereof.

15. The process according to claim 14, wherein the at least one oxygen source is air or an air/oxygen mixture.

16. The process according to claim 14, wherein the at least one oxygen source comprises water vapor and/or carbon dioxide as an oxygen-containing compound.

17. The process according to claim 1, wherein the starting mixture is heated by the introduction of energy and/or an exothermic reaction of the starting mixture.

18. The process according to claim 1, wherein ignition of the autothermal reaction is effected by means of a catalyst introduced for this purpose and/or stabilization of ignition is effected by means of a catalyst permanently present in the porous medium.

19. The process according to claim 1, wherein the reaction in step b) occurs at a temperature of not more than 1400° C.

20. The process according to claim 1, wherein the residence time of the reaction mixture in the reaction zone in step b) is from 0.01 s to 1 s.

21. The process according to claim 1, wherein the reactive products obtained in the oxidative gas phase reaction are at least one selected from the group consisting of alkynes, olefins, dealkylated aromatics and synthesis gas.

22. The process according to claim 1, wherein the rapid cooling of the reaction mixture in step c) is effected by direct cooling, indirect cooling or a combination of direct and indirect cooling.

23. The process according to claim 1, wherein the reaction mixture obtained in step c) is subjected to at least one fractionation and/or purification step d).
